(19) United States
(12) Patent Application Publication
(10) Pub. No.: US 2020/0081524 A1
(43) Pub. Date: Mar. 12, 2020

(54) Method and appartus for data capture and evaluation of ambient data

(71) Applicant: Apple Inc., Cupertino, CA (US)

(72) Inventors: Eberhard Schmidt, Kleinmachnow (DE); Tom Sengelaub, Berlin (DE)

(21) Appl. No.: 15/750,648

(22) PCT Filed: Aug. 5, 2016
(86) PCT No.: PCT/EP2016/068815

§ 371 Date: Feb. 6, 2018

(30) Foreign Application Priority Data
Aug. 7, 2015 (EP) 15180275.8

(51) Int. Cl. G06F 3/01; G06K 9/00

(52) U.S. Cl. CPC G06F 3/013; G06K 9/00671

(57) ABSTRACT

The invention relates to an apparatus and a method for capturing data from the ambient data of an environment (12) of a user by means of a scene image recording device (16) and for the evaluation of the acquired ambient data by means of an evaluation device (22). Here a spatial and/or temporal selection (36a, 36b, 36c) is made which concerns an acquisition of the ambient data by means of the scene image recording device (16) and/or a transmission of the ambient data from the scene image recording device (16) to the evaluation device (22) and/or an evaluation of the ambient data by the evaluation device (22). Furthermore, the selection (36a, 36b, 36c) is made as a function of at least one captured, temporally variable first parameter (30, 32) in order to make this selection on the basis of its relevance and thus to make possible a reduction of the data volume by reduction measures restricted to less relevant data.

### DESCRIPTION

The invention is based on a method for the data capture of ambient data from an environment of a user by means of a scene image recording device and for the evaluation of the acquired ambient data by means of an evaluation device. Furthermore, the invention is based on a corresponding apparatus with a scene image recording device for the data capture of ambient data from an environment of a user and with an evaluation device for evaluating the acquired ambient data.

Numerous possible applications are known from the prior art, in which a data capture of ambient data, for example, in the form of images, by means of a scene camera, as well as their evaluation plays a major role. For example, augmented reality systems, such as augmented reality glasses, can have a scene camera or ambience camera arranged at the front which takes pictures of the user's environment. Furthermore, computer-generated objects can be superimposed on the user-perceived reality by means of such glasses, which in particular can be related to objects of the real environment. For example, additional information about objects in the environment can be superimposed by the glasses. To make this possible, the images captured by the scene camera are evaluated and searched for existing or specific objects. If such objects are found in the image recordings, the corresponding information can be overlaid by the glasses.

In combination with mobile eye-tracking systems, there are numerous other possible applications. If, for example, such glasses also incorporate an eye tracker, the eye-tracking data can be matched with the recorded scene-image data to determine, for example, where in his environment the user is currently looking, in particular, at which object in his environment. In addition, registration processes can also still be used here which make it possible to map an image recording onto a reference image which was recorded, for example, from a different perspective. Such registration processes can be used to accumulate gaze direction data over time as well as covering multiple users in a simple manner by transferring said data to a common reference image. With registration processes, particular objects, significant areas, or significant points in the reference image can be, for example, defined, such as patterns, edges, or points of intersection of edges, which during evaluation of the scene image are searched for in this and identified. By means of the correspondence between the points or areas identified in the scene image and those in the reference image, a transformation can be derived that maps the scene image onto the reference image. This transformation can, for example, be used in the same way in order to map onto the reference image the user's point of regard in the scene image.

In all these methods, in which scene images or scene videos are recorded and evaluated, there is the problem that very large amounts of data may be incurred. Both the data transmission and its evaluation is thus time-consuming and requires a lot of computing capacity. As a result, real-time systems can only be realized to a limited extent or not at all, at least if a high quality is desired or required either with regard to the image recordings themselves or also in the evaluation, for example, in order to make high reliability possible in the recognition of objects in images. Furthermore, possibilities for data reduction are also known, such as compression methods. However, these again have the great disadvantage that such data reduction also leads to information being lost which, in particular, can be very relevant and thus in turn lower to an extreme extent the quality of such a system or apparatus.

It is therefore an object of the present invention to provide a method and an apparatus for the data capture and evaluation of ambient data, which will enable a reduction in data quantities while at the same time minimizing the loss of relevant data.

This object is achieved by a method and an apparatus having the features of the independent claims. Advantageous embodiments of the invention may be found in the dependent claims. The inventive method for the data capture of ambient data from the environment of a user by means of a scene image recording device, such as, for example, a scene camera, and for evaluation of the recorded ambient data by means of an evaluation device is characterized in that a spatial and/or temporal selection is made, which concerns an acquisition of the ambient data by means of the scene image recording device and/or a transmission of the ambient data from the scene image recording device to the evaluation device and/or an evaluation of the ambient data by the evaluation device. This selection is made as a function of at least one acquired and temporally variable first parameter, and is in particular controlled or even regulated.

By making a selection, it is advantageously possible to categorize data, for example, in terms of their relevance, specified by the first acquired parameter. Several temporal and/or spatial selections can also be made here, for example, a first selection for ambient data of the highest relevance, a second selection for ambient data of middling relevance, a third selection for ambient data of low relevance, and so on. Various reduction measures can then be advantageously limited to non-relevant or less relevant data, so that overall the amount of data can be reduced without having to forego relevant information.

In addition, such a selection can advantageously be made along the entire data path from acquisition to evaluation, so that numerous possibilities for data reduction are provided. For example, the selection concerning the acquisition of the ambient data may specify which of the image data captured by the scene image recording device are read out from an image sensor of the scene image recording device and which not, or even how often and at what rate. The selection relating to the transmission of the ambient data may, for example, specify which of the acquired data are transmitted, which not, or also in which quality, for example, compressed or uncompressed. A selection related to the evaluation may, for example, determine which of the data will be evaluated, which not, or which first. A temporal selection may specify, for example, when data are collected, read out, transmitted, or evaluated, when not, or at what rate. In this way numerous options are overall provided on the one hand for making a selection and on the other for possible ways of dealing with the selected and the unselected data, thereby providing numerous optimization possibilities with regard to bandwidth efficiency and data relevance. The invention thus makes possible a significant reduction in the base bandwidth, whereby the gain in bandwidth can again be translated into faster frame rates, faster processing, shorter latencies, lower energy or processing power requirements, simpler interfaces and less expensive components.

Here the scene image recording device can generally take the form of one or more cameras, for example, a classic 2D sensor, a so-called event-based sensor and/or even a 3D camera (for example, TOF, depth map, stereo camera, and so on).

In an advantageous embodiment of the invention, the ambient data selected according to the selection are treated in a first predefinable manner, in particular captured with the scene image recording device and/or read out from the scene image recording device and/or transmitted to the evaluation device and/or evaluated by this, and the ambient data not selected according to the selection either not treated or treated in at least a second predefinable way which differs from the first, in particular, captured again and/or read and/or transmitted and/or evaluated. As a result, advantageously different reduction measures can be applied to the selected as well as to the non-selected ambient data. For example, the selected ambient data can be acquired, transmitted and evaluated at maximum quality, while the non-selected ambient data can, for example, not be utilized at all, whereby the total amount of data can be reduced in a particularly effective way, or at least captured at lower quality, transmitted or evaluated with lower priority, which advantageously still allows use of this data while simultaneously carrying out data reduction.

In a particularly advantageous embodiment of the invention, the ambient data not selected according to the selection are reduced, in particular while the ambient data selected according to the selection are not reduced. In the case of a spatial selection, a reduction of this kind may, for example, be achieved by non-selected image areas not being recorded in the first place, transmitted to the evaluation device or evaluated by it, or by non-selected image areas being compressed, structurally reduced, for example, in their color depth, or similar. In the event of multiple cameras of the scene image recording device being available, a spatial selection can, for example, be also made by selecting one of these cameras for data capture of the ambient data. Alternatively, only selected information levels are recorded by individual or multiple cameras, read out, transferred or processed. This may concern, for example, reduction to edges, depth information, gray-scale values, certain frequency ranges. In this case, a spatial selection, in particular irrespective of whether it relates to acquisition, transmission or evaluation, has the consequence that an image reduced in terms of its data volume as compared with the originally recorded image is provided for the purpose of evaluation. In the case of a temporal selection, the reduction can be achieved, for example, by the image data either not being captured in the first place or being recorded with a low frame rate, transmitted and/or evaluated. As a result of all these measures, it is advantageously possible to reduce the total amount of data, whereby the fact that this reduction is preferably restricted to the non-selected ambient data means that the loss of information with respect to relevant data can be kept as low as possible.

Here it is particularly advantageous if, for the purpose of reduction, in particular of structural reduction, of the ambient data not selected according to the selection, the ambient data not selected according to the selection are compressed. Alternatively or additionally, the ambient data not selected according to the selection may be filtered out. Data compression can be achieved, for example, by binning or color compression, while filtering can, for example, use color filters, for example, to reduce color depth. In this way, the quantities of non-selected data can be reduced without losing the data completely. In the event that the selected data do not turn out to contain the desired information, it is still always possible to have recourse to the unselected data. Alternatively or additionally, as a way of reducing the non-selected data, provision can also be made for reducing a rate concerning the acquisition and/or transmission and/or evaluation of the ambient data not selected according to the selection in comparison with a rate concerning the acquisition and/or transmission and/or evaluation of the ambient data selected according to the selection. As long as, for example, no relevant information is expected in the image recordings, which can, for example, can be specified by the at least one parameter, depending on which this selection is made, the image capture rate can, for example, be kept low and thus also the amount of data to be acquired, transferred and ultimately evaluated—effectively in sleep mode for data capture. Similarly the transmission rate or the evaluation rate can also be reduced. Alternatively or additionally, provision can also be made, particularly in evaluation, for a lower time priority to be given to ambient data not selected according to the selection in comparison with ambient data selected according to the selection. This, for example, makes it possible for a relevant image area to be evaluated and analyzed first of all, and only when the information sought is not found, such as, for example, objects to be detected, can the non-selected data also then be evaluated. This variant saves enormous amounts of time in the evaluation since analysis can begin in image areas for which there is a high probability that the information or objects sought are to be found there. In the case of a 3D scene camera as a scene image recording device, it is also conceivable that only a part of the so-called depth map is used as a reduction measure. This part can in turn be determined or selected as a function of an eye parameter of the user as well as of one or more image characteristics, such as, for example, on basis of the determined gaze direction and its point of intersection with an object, or on the basis of vergency, the accommodation state of the eye, and so on.

The way in which the ambient data not selected according to the selection are reduced, for example, which of the above-mentioned reduction measures is applied, can either be set in advance or be determined by one or more other parameters. For example, this can be done as a function of the image characteristic. In the course of a preliminary analysis of a recorded image it can, for example, be determined whether around the area of the point of regard there are any objects at all or more objects in the image. If user is looking at, for example, a specific point on a white wall, it can be determined on the basis of the preliminary analysis that the ambient data not selected according to the selection should not, for example, be further treated at all rather than only being transferred or evaluated in compressed form. The type of reduction of ambient data can also be implemented as a function of prespecified requirements with regard to a maximum amount of data or the data rate during transmission and/or evaluation so that an appropriate compression type is selected which meets these requirements. The type of reduction can also be selected in dependence on an application or in general on the purpose of data analysis and processing. Should, for example, color information play a subordinate role here and it is good contrast or high resolution which is important instead, color filters, for example, can be selected as a reduction measure instead of using compression measures which reduce resolution as a whole. The selection parameters described for the reduction measures are here advantageous in particular when applied to structural and/or spatial reduction measures.

According to a further advantageous embodiment of the invention, the ambient data selected according to the selection can be enriched by additional data from a data source other than the scene image recording device. Enrichments of this kind may, for example, be pre-defined highlighting, in particular, relating to color or even in relation to contrast, an annotation by the user, for example, by speech input, an annotation of biometric or other user data, and/or an annotation or combination of performance data relating to an action, task or application just carried out or executed by the user.

In the evaluation of the selected ambient data these can advantageously be evaluated with further additional data and, for example, evaluated with regard to precisely that additional information. The data source can, for example, be a further capture device, for example, a voice capture device, a gesture capture device, a pulse monitor, an EEG, or even a memory device in which additional data are stored.

To now be able to suitably specify, for example, which image areas of a captured image contain relevant information or when image recordings do so, several advantageous possibilities also come into consideration for the at least one acquired and temporally variable first parameter, and will be explained in more detail below.

It is especially advantageous when the at least one first acquired parameter represents an eye parameter of at least one eye of the user. An eye tracker, for example, can be used for acquiring the eye parameter. In particular, the eye parameter can here represent a gaze direction and/or a point of regard, in particular an eye movement and/or a visual tracking movement and/or a time sequence of the point of regard, and/or eye opening state, and/or represent an item of information about a distance of the point of regard from the user, such as, for example, a convergence angle of the user's two eyes. The invention is here based on the recognition that in particular objects or significant points, such as corners or edges of objects, attract the attention of the eye, in particular in contrast to, for example, color-homogeneous and non-structured surfaces. For example, if the user looks around in his environment, his eyes look at salient points and areas, such as corners, edges, or objects in general, entirely automatically. This can be exploited in a particularly advantageous manner for object detection in the user's environment since it can be assumed that relevant objects, points or regions are located with very high probability at the point in the environment at which the user is currently looking. The acquired gaze direction can, for example, be compared with the ambient data captured by the scene image recording device in order to determine the point of regard of the user in the corresponding scene image.

Next an area around this registered point of regard in the scene image can, for example, be spatially selected and accordingly treated as a relevant image area by the first predefinable method, while image areas outside this area can be classified as irrelevant or less relevant, and thus cannot be treated for reduction of the volume of data, or if so then by the second predefinable method. Even information about a distance of the point of regard from the user, such as, for example, from an angle of convergence of the two eyes or an accommodation state of the at least one eye, can advantageously be used for making a spatial selection, in particular also for making a three-dimensional data selection. For example, in the case of a 3D scene camera as scene image recording device, only a part of the so-called depth map can be used, in particular even only for the selected three-dimensional area.

The point of regard of the user in the scene image, in particular as a 2D point of regard or even a 3D point of regard, can here in particular be determined by the scene image recording device and the eye tracker working in synchrony to determine the gaze direction and/or the point of regard. For example, the eye tracker can at the same time make an image recording of one eye of the user and from this determine the gaze direction in which the scene image recording device is making a corresponding image recording of the environment in order to collect ambient data. Here the scene image recording device is also preferably so arranged and/or designed that the visual field of the scene image recording device mostly coincides with the visual field of the user or at least with a possible visual field of the user, and in particular encompasses it completely. It is here particularly advantageous when, for example, the scene image recording device here represents part of a head-mounted device which in addition also includes the eye tracker. When the user makes a head movement, the scene image recording device advantageously also moves along with it, thereby keeping said scene image recording device advantageously directed at all times in the direction of the user's field of view. But developments would also be conceivable in which the scene image recording device were arranged, not mounted on the user's head or any other part of the user's body, but rather fixed in one location, for example. The scene image recording device may comprise, for example, one or more cameras, which then preferably cover the largest possible solid angle range of a space.

In this case, for example, a position of the user or of his head in relation to the scene camera coordinate system could also be determined by the scene image recording device and the correspondingly determined gaze direction could also be converted into the scene camera system. This is particularly advantageous when the scene camera system is installed at a distance from the user and the bandwidth for data transmission is low or unreliable. In such cases, the invention allows the use of the available bandwidth for the information essential to the user.

The gaze direction corresponding to an image recording of the scene image recording device at a specific time does not necessarily have to be determined on the basis of image data picked up by the user's eye at the same time. The gaze direction and/or the resulting point of regard can, for example, also be predicted on the basis of one or more previously recorded image recordings of the eye, for example, by means of a Kalman filter or other methods. The idea behind prediction of the point of regard here consists of being able to subdivide eye movements or gaze movements into saccades and fixations, in particular, moving and non-moving fixations. A saccade represents the changeover between two fixations. During such a saccade, the eye does not receive information, but only does so during a fixation. Furthermore, such a saccade follows a ballistic eye movement, so that, for example, by detecting initial values of such a saccade, such as initial velocity, initial acceleration and its direction, it is possible to determine the time point and location of the end point of such a saccade, which ultimately terminates in a fixation, and thus permits predictions. Such predictions of the point of regard can advantageously also be used in the present case in order, for example, to predict the gaze direction or the point of regard for a time at which the scene image recording device then records a corresponding ambient image. In particular, in the case of saccades, the end point can be determined and used for the next temporal and/or spatial selection at the end of the saccade. Latencies can thus advantageously also be shortened. A spatial selection can then be made by shifting the area to be selected or a second spatial area to the point of regard or to the possible points of regard in a prediction window.

However not only the point of regard or the gaze direction can be advantageously used to select relevant and non-relevant data, but also, for example, a viewing pattern or eye movements or temporal point of regard sequences or characteristic eye movement sequences, such as the saccades and fixations just described. Such viewing patterns can preferably be used here particularly advantageously for a temporal selection since, as described, a user does not take in any ambient data during a saccade. Thus, even the points of regard in an image captured by the scene image recording device during a saccade are less suitable for providing information about the presence of relevant objects, points or areas in the image. On the other hand, however, points of regard in the scene image which are to be assigned to a fixation are very suitable for supplying an indication of the presence of relevant objects, points or areas. Since these two states can be distinguished on the basis of the characteristic eye movements for saccade and fixation, and thus can be acquired, these states are particularly well suitable for making a temporal selection with regard to relevant ambient data. For example, it may be provided that image recordings are not made of the environment unless a fixation has been detected. The image recording rate can also be reduced during a non-moving fixation as compared with a moving fixation, for example, can even be restricted to one or a few fixations during a captured or predicted fixation phase since during a non-moving fixation even the point of regard of the user does not change with regard to his environment. Point of regard sequence movements can also be recognized and thus a moving object be classed as being of particular importance. Conclusions can also be drawn from pupil reactions regarding the importance of certain image contents and thus support a selection for recording, transmission, or analysis. These selection and reduction measures described for image recordings can in the same way also be applied additionally or alternatively for reading the image data, transmitting and evaluating the data.

The same also applies to the eye opening state which is also particularly suitable for making a temporal selection for capturing, reading, transmitting and/or evaluating the ambient data. Since the eye, for example, during blinking, cannot supply any information about relevant image areas, it can be provided that only when the eye is open will image recordings be made of the environment by the scene image recording device or only then will these data be transmitted or evaluated, while when a blink is detected, image recordings, whose transmission or evaluation can be dispensed with, or carried out at a lower time rate, or transmitted in compressed form, or reduced by other reduction measures will be so treated.

An acquired eye parameter will thus supply a great deal of advantageous information about where and when relevant information is present in the surroundings of a user or in the corresponding images recorded by the scene image recording device. This advantageously makes it possible to make and even to control the temporal and/or spatial selection in such a way that on the one hand data volumes can be particularly effectively reduced and on the other hand the loss of relevant data is cut to a minimum.

Alternatively or additionally, it can also be arranged that the at least one acquired parameter represents a single image characteristic of an image recorded by the scene image recording device during the capture of ambient data and/or a change in the image characteristic in relation to at least one previously recorded image. It is, for example, especially advantageous here to use as image characteristic the image content of the captured image or the change in the image content of the captured image with reference to a previously recorded image as the at least one first parameter, since, if the image content has changed not at all or only slightly in comparison with a previously captured image, it will be possible, for example, to access previously determined results without having to evaluate the newly captured image. For example, it can also be arranged that as long as the image content has not changed significantly, images will be acquired, transmitted or evaluated at a lower rate or frequency, which in turn makes for enormous savings in data. This image content comparison can be performed, for example, in the course of a pre-processing action, in particular before the image data are transmitted to the evaluation device and evaluated by the same. In contrast to a detailed image analysis, such an image content comparison can be carried out in a way which takes considerably less time and is less computationally intensive. Such an image content comparison can relate to the entire captured scene image or just to a portion of it, as again, for example, to a previous spatially selected area around the determined point of regard of the user. On the basis of a result of such comparison it can then be decided, for example, whether the image data recorded will even be transmitted to the evaluation device or evaluated by it. Other advantageous image characteristics which can be used as the at least one first parameter include, for example, spatial frequencies in the recorded scene, a contrast or contrast curves, the presence of objects, areas, or significant points in the image, a number of objects, areas or points present in the image, or even the arrangement of objects, areas, points, structures and so on present in the image. Such image parameters or image characteristics can be used advantageously in particular to make or control a spatial selection, which will be explained in more detail later.

In a further advantageous embodiment of the invention, the at least one first parameter represents a user input or a detected user characteristic or even any other external event from other signal sources or input modalities. Such parameters may alternatively or additionally also be used to trigger, for example, the recording, the transmission or the transfer and/or analysis or evaluation of individual images or image sequences, and in particular also to control or regulate them. To capture user input, conventional control elements such as buttons, mouse, and so forth may be used, as also gesture detection or the like. This allows the user to actively signal, for example, when interesting or relevant objects fall within his field of view or when he is looking at them. User characteristics may be captured, for example, by detecting the movements of a user, his gestures, by EEG signals or the like. Such characteristics can also give information, whether or not interesting objects are or are not to be found right then in the field of view of the user. It is particularly advantageous here to provide such parameters for a temporal selection of relevant data.

In a further advantageous embodiment of the invention, the spatial selection determines which area of the surroundings is captured by the scene image recording device as the ambient data, in particular in the first predefinable way and/or read out from the scene image recording device and/or transmitted to the evaluation device and/or evaluated by the evaluation device. Along the entire data path from acquisition to evaluation, it is thus advantageously possible to select data on a spatial basis, thereby characterizing the relevant data.

According to a further advantageous embodiment of the invention, the spatial selection is made in such a way—as a function of a captured point of regard of the user—that the area encompasses the point of regard. As has already been described, the point of regard is particularly suitable for the ability to select between relevant and non-relevant or less relevant data. The point of regard is thus particularly well suited as the acquired parameter, as a function of which the spatial selection is made and possibly also time-controlled.

In this context, it may further be provided that the size of the area is fixed in advance, in other words, is not variable but is constant. For example, the point of regard of the user can be determined in a corresponding image of the scene image recording device and then an area defined in terms of its size may be selected around this point of regard as the relevant data. This area can, for example, be specified in advance by a predefined fixed radius around the point of regard or as a fixed image portion with respect to the entire recorded scene image. This represents a particularly simple, less computationally intensive and above all time-saving way to select and define the area with the relevant image data.

Alternatively it can also be arranged that the size of the area is defined or controlled as a function of at least one second parameter. This provides particularly flexible options for selecting the relevant image data. This allows, for example, an adaptive adjustment in order to distinguish even better between relevant and non-relevant data around the point of regard. Suitable as this second parameter is once again and above all an image characteristic of an image acquired during the acquisition of the ambient data by means of the scene image recording device and/or a measure for the accuracy and/or dynamics of the detected point of regard of the user and/or at least one device parameter, such as transmission quality, latencies or performance of the processing device of an apparatus comprising the scene image recording device and/or the evaluation device and/or a size of an object located with at least a partial overlap of the point of regard of the user in an image captured during recording of the ambient data by the scene image recording device. If, for example, the second parameter represents the image characteristic, then on the basis of, for example, the characteristic of the image content, such as, for example, spatial frequency around the point of regard, the number or unambiguousness of the objects or relevant points, object clusters, feature clusters, contrast intensity around the point of regard or objects detected behind, in front of or around the point of regard can be used in order to determine or control the size and also the borders of the area to be defined. This makes it possible, for example, to define the area in such a way that an entire object at which the user is currently looking can always be covered or, for example, a contiguous area, or everything from the point of regard as far as the next edge (start burst), and so on. It is therefore particularly advantageous to define or control the size of the area depending on a size of an object on which the point of regard is resting or which is at least in a predetermined proximity to the point of regard of the user so that in particular the entire object or even an object group is always co-selected. This advantageously increases the probability that the relevant information to be acquired is also completely covered by the selected area. It is also particularly advantageous to provide the measure for the accuracy of the determined point of regard of the user to be the second parameter. For example, if the eye-tracking quality is poor, it may be that the determined point of regard deviates greatly from the actual point of regard of the user. However, so that as far as possible all relevant data are detected or selected, it is particularly advantageous, in the case of less accurate determination of the point of regard, to increase the area to be selected around the point of regard in contrast to the case of higher accuracy in determination of the point of regard. The accuracy of the determined point of regard can be calculated or estimated by known methods, such as from the viewing quality of the image taken by the eye tracker, the temporal scatter of point of regard values, and so on.

Even the dynamics of the point of regard can also be taken into account advantageously in the control of the size of the area. If the point of regard has a high dynamic over time, in other words, it moves or jumps swiftly within a large surrounding area, the size of the area to be selected can then be selected correspondingly larger. Various other device parameters can also be considered in defining the size of the area. For example, given an overall low performance of the apparatus or low computational power, low transmission bandwidth and so on, the area to be selected may be selected correspondingly smaller in size in order to reduce the amount of data to be transmitted or evaluated, thereby shortening latencies or keeping them within predefinable limits. In contrast to this, with higher performance of the apparatus a correspondingly larger area may also be selected. Such performance parameters can, for example, affect both transmission and evaluation as well as various other components of the apparatus. It can also, for example, be provided that the user himself or another person can specify to the system this second parameter for defining the size of the area. The user himself can thus set his own priorities regarding time efficiency or data reduction, and the quality of the result. The larger the area selected, the more likely it is that all of the relevant information from this area will be covered, while the smaller this area is selected, the fewer data must be read out, transmitted and/or evaluated.

In a further advantageous embodiment of the invention, the temporal selection determines when, in particular in the first predefinable way, an area of the environment is captured by the scene image recording device as ambient data and/or read out from the scene image recording device and/or transmitted to the evaluation device and/or evaluated by the evaluation device. In the same way as with spatial selection, a selection of data can advantageously be made with regard to the entire data path. Numerous possibilities for data reduction are thus provided, for example, already during data acquisition, or not until transmission or ultimately, not until evaluation of the acquired data.

In this case, it is furthermore particularly advantageous if the temporal selection is made as a function of the at least one first parameter such that only then or in the first predefinable way images are captured, for example, at a higher temporal rate, uncompressed, unfiltered, and so on and/or recorded image data are read out and/or evaluated by the evaluation device when the at least one first parameter fulfills a prespecified criterion. In data selection there is therefore the possibility of either not further treating non-selected data at all, in particular of not even capturing said data in the first place, or reading, transmitting and/or processing these data in a reduced manner, such as by compression or filtering or less frequently. Via the at least one acquired first parameter, time-based control of the selection can thus advantageously be made so that data volumes can again be reduced by data classed as less relevant not even being processed or at least being processed at lower quality on account of reduction without thereby affecting the quality of relevant data.

One particularly advantageous embodiment of the invention further envisages that the prespecified criterion that what is captured is that a viewing pattern and/or an eye movement and/or a visual tracking movement and/or a fixation of the eye which is captured and/or predicted as the at least one first parameter, has a prespecified characteristic. As described earlier, the presence of a fixation of the eye makes it possible to deduce the existence of relevant ambient data; even slow and continuous eye movements can, for example, suggest that the eye is tracking a moving object, which can be categorized as relevant ambient data, and so on. Alternatively or additionally, the prespecified criterion can be that on the basis of the opening state of the eye as the at least one first parameter it is understood and/or predicted that at least one eye of the user is open. It is precisely with methods in which the point of regard of the user in relation to objects in his environment is to be analyzed and evaluated that a particularly advantageous way is found of reducing data volumes by not even considering image recordings during which the user closed his eyes, for example, by blinking, since they contain no relevant information. Alternatively or additionally, the prespecified criterion can also be that on the basis of the image characteristic as the at least one first parameter it is recognized that there has been a change in at least one part of the image content in comparison with at least one part of the image content of a previously recorded image which exceeds a prespecifiable level. If the image content does not change or not significantly, the newly captured image will not contain additional, new or relevant information either, which means that the amount of data can also be advantageously reduced. Alternatively or additionally, the prespecified criterion can also be that a user input is detected as the at least one first parameter. This allows the user to inform the system himself when particularly relevant information lies within his field of view. Alternatively or additionally, it can be also arranged that the user passively provides information about the existence of relevant information in his field of vision, for example, by a prespecified user state being detected or predicted as the at least one first parameter on the basis of a user characteristic, such as, for example, EEG signals. Even user behavior, such as, for example, gestures or the like, can be analyzed to provide information about the existence of relevant information in the user's environment. The criteria mentioned can be provided either singly or even in combination, thus affording numerous possibilities of being able to characterize situations in which relevant information, in particular relevant ambient data are available, and situations in which such relevant ambient data are not available.

In a further advantageous embodiment of the invention, following capture of the ambient data and before evaluation of the ambient data, a pre-processing of the ambient data is carried out in which the selection is made and/or in which the first predefinable way is determined, which is assigned to the ambient data selected in accordance with the selection and/or in which the second way is determined, which is assigned to the ambient data not selected in accordance with the selection. A pre-processing step of this kind is in particular especially advantageous when the spatial and/or temporal selection is to be made as a function of an image characteristic of the ambient data acquired as an image. Here it can also be arranged for a first selection to be made even before the ambient data is pre-processed so that only selected ambient data are even subjected to pre-processing. For example, it can be arranged that this first selection is made on the basis of the determined point of regard of the user in the corresponding scene image recording, and correspondingly only one area of the image around the point of regard being examined for image characteristics during pre-processing, such as, for example, contiguous areas or the presence of objects, edges in the area of the point of regard, whereby then, for example, the final size of the area around the point of regard is set according to a second selection so that only the data which concern this area are even translated or finally evaluated. It can also be determined in the course of such pre-processing whether the image content of the currently captured scene image has changed significantly from a previously recorded image content. By means of such pre-processing a selection can be made in a very time-efficient way of relevant and less relevant image information and the type of further processing can also be specified for the selected or non-selected data in question.

Furthermore, the invention concerns an apparatus with a scene image recording device for the data capture of ambient data from an environment of a user and having an evaluation device for evaluating the acquired ambient data. Here the apparatus is designed to make a spatial and/or temporal selection which concerns an acquisition of the ambient data by means of the scene image recording device and/or a transmission of the ambient data from the scene image recording device to the evaluation device and/or an evaluation of the ambient data by the evaluation device as a function of an acquired time-variable first parameter.

The advantages mentioned for the method according to the invention and its embodiments apply in the same way to the apparatus according to the invention. In addition, the process steps referred to in connection with the method according to the invention and its embodiments make possible the further development of the apparatus according to the invention by means of additional concrete features. In particular, the apparatus is designed to perform the method according to the invention or one of its embodiments.

Furthermore, the apparatus has an eye-tracking device which is designed to capture the at least one first parameter. This is particularly advantageous since eye parameters, such as the gaze direction, point of regard and so on are particularly suitable for selecting image data captured with the scene image recording device into data of more or less relevance.

Furthermore, it is advantageous when the apparatus comprises a head-mountable apparatus, for example, augmented reality glasses, whereby the head-mountable apparatus includes the scene image recording device and at least a display device, and preferably the eye-tracking device. Additional information and objects can be displayed and superimposed on the real-world environment. To make correct positioning possible with respect to the real surroundings of such overlaid objects or information it is necessary to identify the relevant objects in the environment of a user, which can be done by the invention in a particularly time-efficient, not computationally intensive way. The evaluation device can, for example, also be integrated into the head-mountable apparatus, or even be provided as an external evaluation device, for example, as a calculator, computer, and so on, whereby the head-mountable apparatus is then designed to transmit the data selected according to the selection in the first prespecifiable way to the external evaluation device, for example, either wirebound or wirelessly and correspondingly transmit the data not selected in accordance with the selection either in the second prespecifiable way or not at all. Selecting relevant image data thus significantly reduces the time spent even in a subsequent video analysis of the scene videos or video images. Overall the invention can be used advantageously in numerous fields of application such as, for example, in mobile eye-tracking to reduce the bandwidth of the scene video by restrictions to the area of the foveal or expanded foveal point of regard of the user, in augmented reality applications likewise for reducing bandwidth. In addition, the area of the scene, onto which an overlay, that is, information or objects to be superimposed, must be plotted, can be reduced in size. In addition, objects can be marked visually to confine to them the recording with the scene camera. Also the invention offers advantageous and numerous applications in automatic scene video analysis, in which, for example, only an area around the point of regard in the scenes is transmitted and, for example, is registered with a reference, in other words, with a reference video or a reference image. A significant reduction in the base bandwidth is thus possible in all fields of application. Advantageously, image sections, image section content, and recording, transmission and processing frequency can be controlled by means of certain control criteria in such a way that the amount of data is markedly reduced in comparison with the original video but without losing the critical, that is, the relevant information.

Further advantages, features and details of the invention emerge from the following description of preferred exemplary embodiments as well as the drawing.

They show:

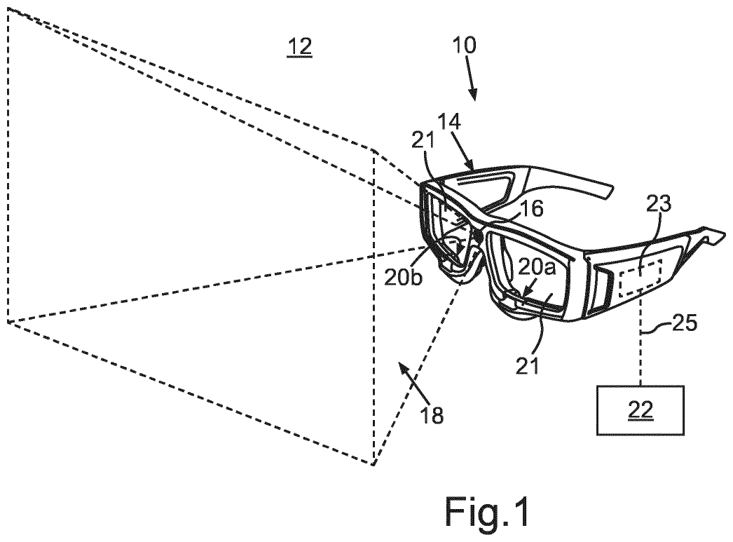

FIG. 1 a schematic representation of an apparatus for the data capture of ambient data and for the evaluation of the acquired ambient data in accordance with an embodiment of the invention;

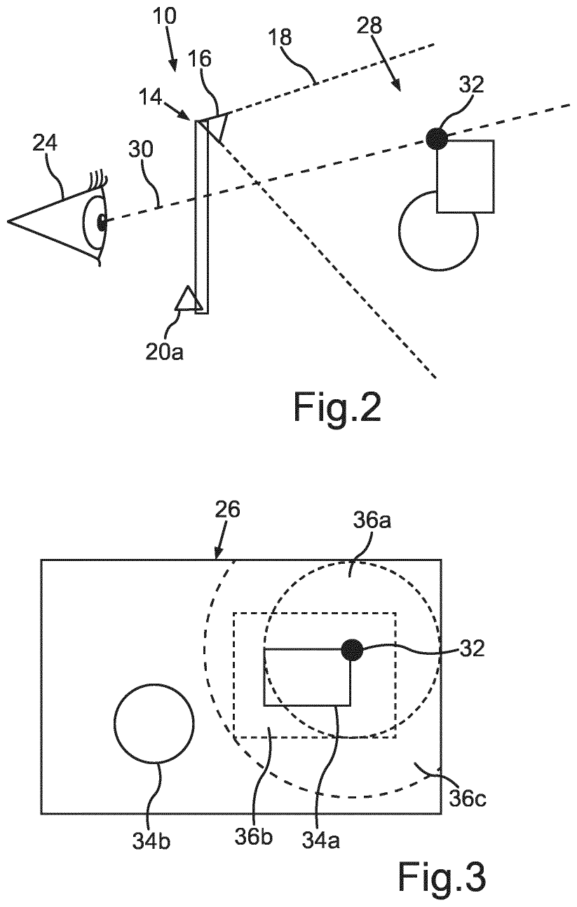

FIG. 2 a schematic cross-sectional view of the apparatus for data capture and evaluation according to an embodiment of the invention;

FIG. 3 a schematic representation of captured ambient data in the form of a scene image to illustrate a method for data capture and evaluation according to an embodiment of the invention;

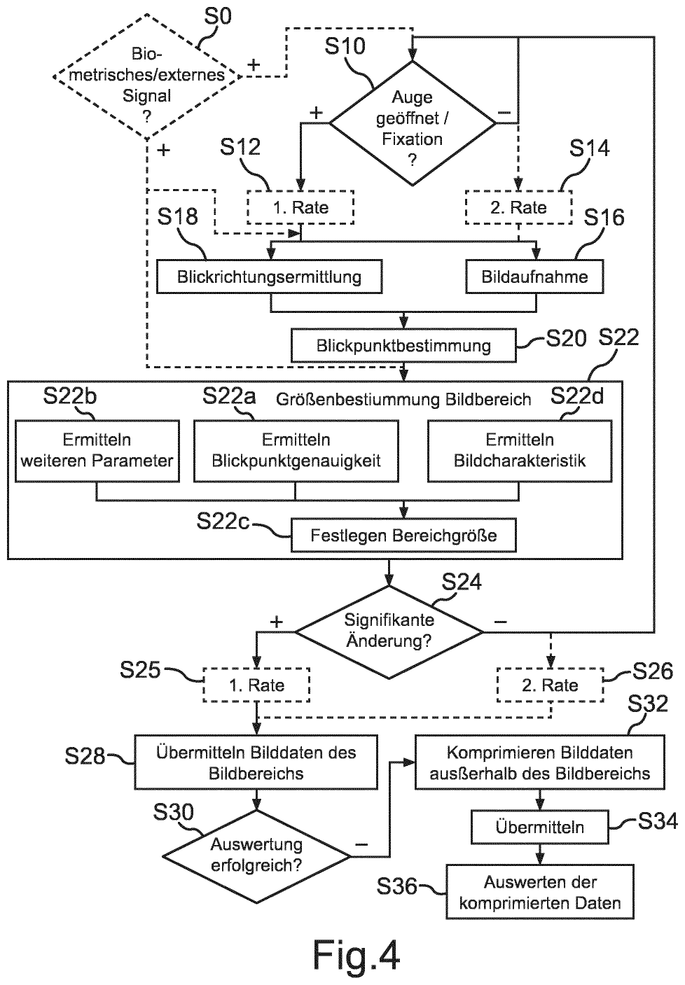

FIG. 4 a flow chart illustrating a method for data capture and evaluation according to an embodiment of the invention;

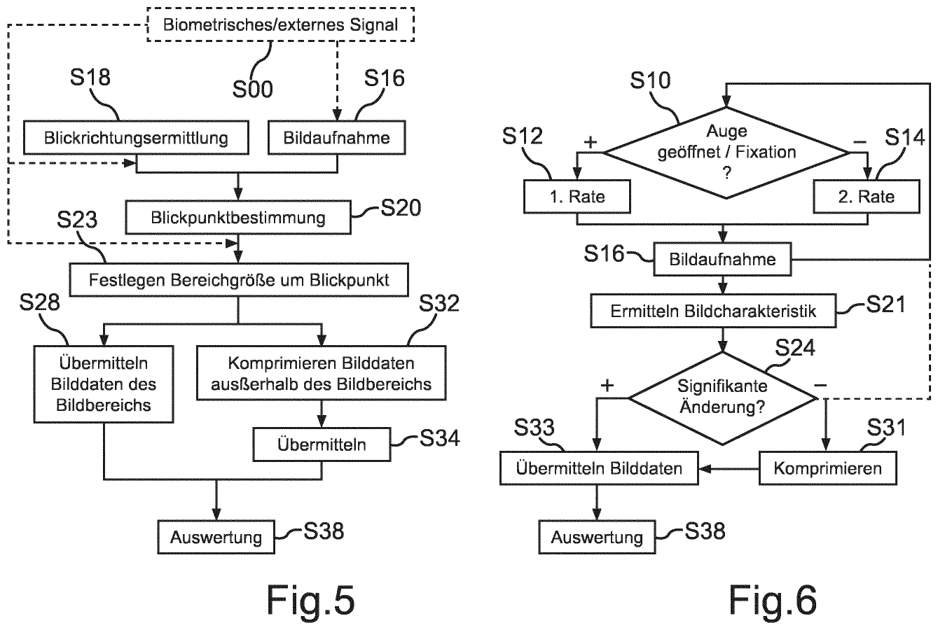

FIG. 5 a flow chart illustrating a method for data capture and evaluation, in particular with a spatial selection of ambient data, according to an embodiment of the invention; and

FIG. 6 a flow chart illustrating a method for data capture and evaluation, in particular with a temporal selection of ambient data, according to an embodiment of the invention.

FIG. 1 shows a schematic representation of an apparatus 10 for the data capture of ambient data from an environment 12 of a user and for their evaluation according to an embodiment of the invention. The apparatus 10 here comprises a head-mountable apparatus which here takes the form of a pair of glasses, and which can, for example, take the form of augmented reality glasses or data glasses or even take the form of conventional glasses with or without spectacle lenses. The head-mountable apparatus could also be designed in any other way, for example, as a helmet or similar.

These glasses 14 further comprise a scene image recording device designed as a scene camera 16, which is arranged at the front and in the center of the glasses 14. The scene camera 16 has a field of view 18, which is intended to be indicated in FIG. 1 by dashed lines. Areas of the environment 12 within the field of view 16 of the scene camera 14 can be mapped on the image sensor of the scene camera 16 and thus acquired as ambient data. This field of view 18 is here preferably arranged such that it at least partially overlaps with a field of view of a user who is wearing the glasses 14, preferably mostly or even entirely covering said field of view. Furthermore, the glasses 14 comprise an eye tracker with two eye cameras 20a, 20b, which in this example are arranged on the inside of the frame of the glasses 14, so that they can in each case acquire images associated with the corresponding eye of a user wearing the glasses 14 in order to evaluate these image recordings regarding, for example, determination of gaze direction, determination of point of regard, detection of viewing patterns, blink detection, and so on. Furthermore, the glasses 14 have an optional pre-processing device 23, which can carry out pre-processing steps on the image recordings, in particular of the scene camera 16, said steps being explained in more detail later. Furthermore, the apparatus 10 has an evaluation device 22, which in this example represents a device external to the glasses. The evaluation device 22 can furthermore be coupled either wirelessly or by wire to the glasses 14 via a communicative connection 25, for example, a data line. For example, it may also be provided that the scene camera 16 initially records a scene video and the corresponding data are first stored in a memory (not shown) of the glasses 14, and only at a later time is the communicative connection 25 made between the glasses 14 and the evaluation device 22 in order to read out the data stored in the memory and transmit them to the evaluation device 22. Alternatively, however, this evaluation device 22 could also be integrated in the glasses 14. Furthermore, the glasses 14 can optionally have displays 21, by means of which, for example, additional digital information or objects in view in the environment 12 can be displayed as overlays.

Such an apparatus 10 can now be used for a variety of applications. For example, a scene video can be recorded by means of the scene camera 16 while a user is wearing the glasses 14 and is, for example, moving about the environment 12. Meanwhile the eye cameras 20a, 20b can record images of the user's eyes to determine from these the gaze direction corresponding to the respective image recordings of the scene video. The acquired data can now, for example, be transmitted to the evaluation device 22 which evaluates the image data of the scene camera 16 and of the eye cameras 20a, 20b. For example, a scene video can be created by marking the user's point of regard at the respective time points. Furthermore, it is also possible to visualize the temporal course of the point of regard in a single image, for example, a reference image, as an accumulation of these points of regard. Such a reference recording can, for example, also represent an image recording of the environment 12, which was also made by means of the scene camera 16 or even by means of another image recording device. In order to now be able to transfer the recorded points of regard to this reference image, the image recordings of the scene camera 16 must be registered with the reference image. This can be done, for example, by marking significant points or objects in the reference image which are searched for and identified in the respective images of the scene video in order to derive, for example, a transformation which maps a respective scene image onto the reference image. In this way, the points of regard of the user at the respective times can then be mapped onto the one reference image. By accumulating such points of regard it is possible, for example, to make statements about which objects in the environment 12 attract the attention of a user, and which less so. Measures of this kind can, for example, be used for consumer behavior research, or even for other studies. Here such a procedure can be carried out not only for one user but also for several users who, for example, are each wearing such glasses 14 or wearing the glasses 14 in succession. In addition, registration procedures can also be used to facilitate an interaction, for example, between multiple users, as well as for a live analysis, for example, during a tour or a trial of sales offers or objects. For example, the respective current points of regard for a first user with respect to his environment can be determined and for a second user, who is viewing the same environment but from a different perspective, these points of regard of the first user can be overlaid via the display 21 of the second user's glasses 14 at the corresponding locations, in particular even in real time, so that the second user can track which objects in the environment the first user is currently looking at.

Very high data volumes are usually incurred with such methods, making both data transmission and also data evaluation extremely time-consuming and computationally intensive. In other applications in which, for example, an online data evaluation is required, in particular in order to be able to provide real-time systems, and in which, moreover, the evaluation device is not to be provided as an external device but rather as an evaluation device 22 integrated in the glasses 14, whereby the computing power provided by the evaluation device 22 is additionally limited, these large amounts of data continue to provide major problems. This applies, for example, to augmented reality glasses, in which additional digital information is to be inserted via the glasses 14 into the environment 12, and also in the correct position with respect to the environment 12. In a similar fashion to the registration of scene images with a reference image, the overlays to be overlaid must be registered with the ambience recordings provided by the scene images.

The invention advantageously now makes it possible to reduce these enormous amounts of data without losing essential information, which would greatly reduce the quality of such a method. This is accomplished by making a selection in relation to the ambient data. This selection can take place during data acquisition by means of the scene camera 16, when reading the data from the scene camera 16 or its image sensor, when transmitting the data to the evaluation device 22 as well as during evaluation by the evaluation device 22. For this purpose, the apparatus 10 may have at least one control device, which may, for example, be part of the pre-processing device 23, the evaluation device 22, the scene camera 16 and/or the eye tracker, or take the form of a further separate control device for controlling data acquisition, reading out the data, data transmission and their evaluation as well as making the selection. In particular, the one or more control devices may include a processor device that is configured to perform one or more embodiments of the method according to the invention. For this purpose, the processor device can have at least one microprocessor and/or at least one microcontroller. Furthermore, the processor device can incorporate program code which is designed to execute the embodiments of the method according to the invention when executed by the processor device. The program code may be stored in a data memory of the processor device.

By means of a selection concerning the ambient data, a data selection with regard to relevant and less relevant data can advantageously be made. This selection can be made advantageously both temporally and spatially. Examples of a spatial selection are described below in more detail with reference to FIG. 2 and FIG. 3.

The selection is made depending on at least one acquired parameter. This parameter serves to categorize or estimate the relevance of the ambient data. Numerous parameters come into consideration here, on the basis of which such a categorization can be made. Especially advantageous here is above all the gaze direction or the point of regard of the user with respect to a recorded scene image. This is because the eye automatically targets significant areas, points or objects in its surroundings. The point of regard in the image can thus be used advantageously to find the most likely location of significant points, objects or areas in the scene image.

FIG. 2 shows a schematic representation of the glasses 14 of the apparatus 10 in cross-section and also an eye 24 of a user who is looking through the glasses 14. The scene camera 16 here captures an image 26 (see FIG. 3) from a surrounding area 28, which is located in the field of view 18 of the scene camera 16. Furthermore, the eye tracker takes one or more pictures of the user's eye 24 with the eye camera 20a, on whose basis the gaze direction 30 of the eye 24 at the time of acquisition of the ambient image 26 is determined. The point of regard 32 in the captured scene image 26 can be calculated on the basis of the determined gaze direction 30 and of the corresponding captured scene image 26.

FIG. 3 shows a schematic representation of a captured scene image 26 of this kind, with the point of regard 32 calculated in relation to it. Furthermore, objects in the scene image 26 are indicated by 34a and 34b. An area around the point of regard 32 can now be selected since the likelihood of finding an object, a significant point or area near the point of regard 32 is at its highest. There are now also several possibilities for selecting this area. In one particularly simple embodiment the size of this area can be pre-set by a fixed parameter, such as, for example, an image section or radius around the point of regard 32, as shown in this example in FIG. 3 for the area 36a. Even better results can be achieved, for example, if this area can be adjusted adaptively, for example, by means of a feedback loop. For this type of adaptive adjustment, the characteristics of the image content, such as, for example, the spatial frequency around the point of regard 32, the number or unambiguousness of features or feature clusters, objects, areas of interest, contrast levels around the point of regard 32, can, for example, be considered. Investigation of the image characteristic in the area of the determined point of regard 32 can, for example, be carried out during the course of a pre-processing process by the pre-processing device 23. In this way contiguous surfaces or objects can be detected, such as object 34a in this example, and the area to be selected 36b can then be selected such that the selected area 36b always encompasses an entire object 34a, which is currently being looked at, or a contiguous surface or, starting from the point of regard 32, everything up to the next edge.

Such a selection now makes it possible to carry out data reduction in a particularly advantageous manner. For example, it may be arranged that only the selected area 36a, 36b is recorded by the scene camera 16, is read out from this, is transmitted to the evaluation device 22 or is evaluated by the evaluation device 22. Alternatively it may also be provided that of the selected area 36a, 36b various image areas of the scene image 26 are further processed in a reduced manner, being, for example, captured at a lower resolution and transmitted or evaluated after compression by compression algorithms.

In addition, not just one but, for example, even two or more selected areas can be provided, as is illustrated in FIG. 3 with the aid of the first selected area 36a and a further selected area 36c. This makes it possible, for example, to carry out a gradual or even a continuous data reduction from the acquired point of regard 32. For example, the image data in the immediate vicinity of the point of regard 32 can be treated without reduction to achieve a maximum quality while the data outside of this first area 36a and inside the second area 36c can be treated in a reduced way, for example, compressed or with lower priority, while the remaining data outside the area 36c and the area 36a are either not treated at all or if so, then in a further reduced way as compared with the data in the area 36c. In this way it can, for example, be arranged that image areas, the more peripherally they are located in relation to the point of regard 32, the higher the compression or other reduction measures they will undergo, and image areas in the foveal area will be provided as uncompressed scene videos (for example, with F1264 per macroblock 16×16). Image data can thus be assigned to multiple relevance classes, whereby preferably the further away image areas are from the point of regard 32, the lower the relevance assigned to them. This can also be provided by different levels and/or types of compression based on human vision.

However not only can a spatial selection be used for relevance-dependent data reduction but also, for example, a temporal selection of data can be made. Such a temporal selection means, for example, that, if multiple images 26 are recorded as an image sequence, they can be classed as relevant or less relevant depending on the time of their recording, and correspondingly selected on a temporal basis. Such a temporal selection can, for example, be event-controlled. If, for example, a blink of the user is detected or if for other reasons the point of regard 32 cannot be determined at a particular time or for a particular time period, the image data acquired during this period can be classed as less relevant or even no image recordings at all be made during a period classed as less relevant. It can also be provided that image data are only classed as relevant when they have a significant change of content compared with a previously captured image. In addition, temporal and spatial selection can also be advantageously combined as desired. For example, it can be provided that image data outside of a spatially selected area 36a, 36b are read, transmitted or processed at a lower frequency or rate than image data assigned to the selected areas 36a, 36b.

FIG. 4 shows a flowchart to illustrate a method for ambient data capture and evaluation, which in particular unites spatial and temporal selection, according to an embodiment of the invention. According to this example, images 26 of a user's environment are recorded by the scene camera 16 in a temporal sequence, for example, in the form of a video, whereby a particular image recording is illustrated by S16. Furthermore, on the basis of the viewing data, which are captured by the eye tracker, the gaze direction is determined in S18 for a particular image recording and based on the determined gaze direction and on the corresponding image recording in S20 the point of regard of the user in the corresponding image 26 is determined. In this example, a temporal selection has already been made upstream for the purpose of data reduction. To this end a check is made first in step S10 to see whether, for example, an eye of the user is open and/or a fixation of the eye has been detected or has been predicted for the time of the subsequent image recording in S16. This information can, for example, also be acquired on the basis of the viewing or eye data determined by the eye tracker. According to a first embodiment, it can be provided that an image recording and a corresponding determination of gaze direction only take place when the eye is open or when a fixation is detected or predicted. If this is not the case, the check to see whether the eye is open or a fixation has been detected or predicted will be repeated until this is the case. According to a further embodiment, however, provision may also be made for the case that the eye is open or a specific eye movement, such as the fixation or a saccade, has been detected with a first rate being specified in S12 for image recording and determination of gaze direction, while when the eye is closed or, for example, no fixation has been detected or predicted, a second rate, which is lower than the first rate, is specified in S14 for image recording in S16 and for the determination of gaze direction in S18. These rates relate to the image recording rates for image recording in S16 and possibly also to the corresponding determination of gaze direction in S18. In other words, image recording takes place less frequently or at a reduced rate for as long as an eye is closed or the eye is not fixed on a specific point or area. If, on the other hand, it is detected that the eye is open or a fixation is being made, a change is made to a higher recording rate. This rate is maintained until it is detected that the eye is closed or, for the case of a detected fixation of the eye, for example, even only for a definable duration. It may also be provided within the scope of this temporal selection that a reduction is made to one or only a few images per fixation. A fixation can, for example, also be detected on the basis of an off-line fixation detection capability, which can be used, for example, for an additional or alternative selection of the ambient data in a subsequent evaluation of the data.

An additional time selection could optionally also be made in S20 when determining the point of regard 32 in FIG. 26. If, for example, the point of regard 32 of the user lies outside the field of view 18 of the scene camera 14 and does not therefore fall within the captured image 32, the image recording may then be discarded and a transition made to the next image recording.

Other biometric characteristics or even external signals can also be used, alternatively or additionally, as a further optional selection criterion or as further selection parameters, which is to be illustrated in SO. Here, a biometric signal based on a detected biometric characteristic of the user, such as a pulse rate, a pupil contraction and so on is checked to see whether it satisfies a criterion. Alternatively or additionally, a check can also be made in SO to see whether a signal has been received from an external apparatus and/or whether such an external signal meets a criterion. Such signals can then be used, for example, to trigger or start the procedure and only then to start the check in S10. Such biometric and/or external signals can also be used in addition to or as an alternative to the check in S10 so that, for example, a determination of gaze direction in S19 and an image recording in S16 are not carried out unless a signal has been received in SO or such a signal satisfies a criterion. Optionally, such a signal can also be used to decide when specification of the image area size in S22, which will be described in more detail below, is carried out according to S22 and when not, and, for example, a transition is made directly to S24.

If an image 26 has now been captured in S16 and in S18 the corresponding gaze direction determined, and the corresponding point of regard of the user in FIG. 26 has also been determined in S20, the size of an image area around the point of regard 32 will be determined in S22 during the course of a spatial selection. In order to enable the best possible adaptation to the situation, specification of the image area size in this example is carried out dynamically, that is, as a function of one or more further parameters. One such parameter may, for example, represent the accuracy of the point of regard, which is determined in S22a. An estimation of the accuracy of the point of regard can, for example, be based on image characteristics or the image quality of the image taken by the eye tracker to determine the gaze direction and the point of regard, doing so by statistically analyzing several viewing data, for example, their scatter, or even many other parameters. It can thus be advantageously arranged that when the accuracy of the point of regard is lower in comparison with a greater accuracy of the point of regard the area size is selected larger. In this way it can be arranged that the area size is dynamically controlled as a function of the accuracy of the point of regard or, in general, of a quality measure of the determined point of regard 32, so that, for example, the section radius of the area around the point of regard 32 is increased when the accuracy of the determination of the point of regard falls.

In addition, another parameter can be determined or specified in S22b, such as, for example, a threshold value for the accuracy of the point of regard described above, so that a resizing of the image area, for example, does not take place until the accuracy of the point of regard falls below this threshold value, the size of the image area otherwise always assuming the same predefined value or the area size being defined in S22c independently of the accuracy of the point of regard. Other parameters may also be determined alternatively or additionally in S22b, such as once again biometric and/or external signals, so that the area size can also be specified in S22c as a function of such signals.

An image characteristic of the recorded image 26 can, for example, also be used as an additional parameter for specifying size. For example, the area encompassing the point of regard 32 should be selected such that objects at which the user is currently looking are also completely contained in this area. Such image characteristics can be determined as part of a preliminary analysis or pre-processing of the recorded image 26, in which the image content can be analyzed by analyzing spatial frequencies around the point of regard 32, the contrast intensity around the point of regard 32 can be taken into account, and the presence of objects, edges, or the like around the point of regard 32 can be taken into account. The area size of the image area encompassing the point of regard 32 in image 26 is finally defined as a function of these parameters which were determined in S22a, S22b and S22d.

An additional temporal selection, which will be described below, may now optionally be added to follow this spatial selection. According to this temporal selection, a check can now be made in S24 to see whether the image content of either the entire image 26 or only the image content of the area selected in S22 has changed significantly in comparison with a previous image recording. If this is not the case, according to a first embodiment, all image data relating to the current image recording can be discarded and the procedure can pass on to the next image recording. This can be repeated until a significant change in the image content is detected in S24. Only then will the data, at least the image data of the selected image area, be transmitted in S28 to the evaluation device 22. According to a further embodiment, however, first and second rates for the transmission of the image data can also be set here as well. If, for example, a significant change is detected in S24, the image data of the selected image area may be transmitted at a first rate in S25. If, on the other hand, no significant change is detected in S24, the image data of at least the selected image area may be transmitted in S26 at a second rate which is lower than the first rate since in this case the image data are to be classed as less relevant. Finally, if the image data of the selected image area have now been transmitted in S28 to the evaluation device 23, and in particular evaluated by it, a check can be made in step S30 to see whether evaluation of these image data was successful. This can be assessed, for example, on the basis of predefined criteria, such as whether objects were detected in the selected and evaluated image area, whether predefined objects were detected in this image area, whether predefined significant points or areas could be recognized in this image area, and so on. If this is the case, then the method can be terminated, least for the current image recording, and the described method is carried out for further image recordings in the same way. If, on the other hand, evaluation was unsuccessful in S30, for example, when no objects or significant points could be identified, the procedure can continue with an analysis of the non-selected image area. To do so, the image areas not selected in S22 or the image data associated therewith can first be compressed in S32 in order to reduce the amount of data, transmitted in S34 to the evaluation device 22 and then evaluated by it in S36.

The invention thus provides numerous ways of being able to select the data according to their relevance both spatially and temporally, in particular in the most diverse ways and by many possible criteria in order to make data reduction possible without loss of relevant image content. The selection steps can here be implemented in any combination as well as individually, as can be seen from the simplified examples in FIG. 5 and FIG. 6.

Here FIG. 5 shows a flow chart to illustrate a method for the data capture and evaluation of ambient data, according to which in particular only a spatial selection is made, according to a further embodiment of the invention According to this procedure, in S16 an image recording of the environment 12 of a user is made by the scene camera 16, whereby in S18 the eye tracker determines or predicts a gaze direction which corresponds to the time of the image recording. The point of regard 32 of the user in the captured image 26 is again identified in S20 from the determined gaze direction and the image recording. An area size of the area around the point of regard 32 is then defined in S23. The area size can, for example, be specified in advance by a fixed parameter, such as a predefined fixed radius around the point of regard 32. Next the image data of the selected area around the point of regard 32 are transmitted in S28 to the evaluation device 22. The image data outside the area specified in S23 are on the other hand first compressed in S32 and only then transmitted in S34 to the evaluation device 22. This then evaluates the data transmitted in S38, possibly in a predetermined sequence, for example, first the data of the selected image area and only after this the data of the non-selected image area. By this method, too, image data can, by a spatial selection of an image area, be advantageously sorted into relevant and less relevant data and in sum a data reduction be provided by compression of the less relevant data without the need to forgo relevant information. Even with this method the acquisition of a further parameter, such as a biometric or an external signal, as shown in S00, can be provided as a option, said parameter, for example, triggering image recording in S16 and/or determination of the point of regard in S20 and/or in dependence on which the area size is specified in S23.

FIG. 6 shows another flowchart to illustrate a method for the data capture and evaluation of ambient data, in which in particular a temporal selection is made with regard to data capture, in accordance with an embodiment of the invention. During the course of this temporal selection a check is once again made in step S10 to see whether the eye of the user is open or whether both eyes of the user are open and/or a fixation of the eye is detected or at least predicted for the time of the subsequent image recording in S16. If this is the case, a first rate for image recording in S16 is set in S12. This first rate, that is, the image recording rate, is retained, that is, in particular for the subsequent image recordings as long as it is detected in S10 that the eye is open and/or a fixation is detected. If, on the other hand, this is not or is no longer the case, in S14 a second rate is set for image recording in S16, which is lower than the first rate since it can then be assumed that the relevant image recordings contain less relevant information and thus quantities of data can be saved at the same time. After an image recording in S16 one or more image characteristics are determined in S21 during the course of a pre-processing process on the image data, for example, by the pre-processing device 23. This image characteristic may, for example, concern the image content of the captured image 26, whereby in the following step S24 a check is made to see whether this image content has changed in a significant way, for example, to a predefined extent, compared with a previous image recording. If this is the case, image data are transmitted in S33 to the evaluation device 22. If, however, this is not the case, the image data can be assumed to be less relevant and are then first compressed in S31, and only then transmitted in S33 to the evaluation device 22, which thereupon evaluates the transmitted image data in S38.

The point of regard 32 (2D or 3D) calculated with the eye tracker can here too be used with reference to the scene camera coordinate system to define a relevant image section spatially and possibly temporally as well. This image section can then be read from the scene camera sensor, transmitted or further processed, either alone or with an additional reference section, for example, a frame on the outside edge of the scene image 26, a few lines at the top, bottom or the side in the scene image 26. Thus it is therefore explicitly included that the entire scene image 26 is transmitted but only one area is analyzed as an A01 (area of interest).

In all cases pre-processing of the image 26 in part or entirely can also be carried out in order to determine precisely the scope and type of data reduction. To do so, either the entire image 26 is read or just a specific section of it, then pre-analyzed completely or partially in order to then determine the image characteristic and, if applicable, a further data reduction or compression carried out for the subsequent reading, transmission and/or final processing.

Numerous possibilities are thus provided for reading, transmitting or evaluating ambient data by means of a spatial and/or temporal selection on the basis of an estimate of their relevance, whereby the data volumes can as a whole be considerably reduced while at the same time the likelihood of losing relevant data or information can be kept low. An apparatus and a method for the gaze-controlled recording of videos for their efficient forwarding, processing and preferably for the registration of relevant image content to each other and to other references such as videos and images are thus provided, which exploit the point of regard in the image and/or another external parameter and/or information or image content or image structure, either once in the selection of an object or continuously, to use it in determining a relevant target area, here using either the continuous viewing data or only the fixation data on the basis of an on-line fixation detection on the one hand and an analysis of this image area on the other. Only a relevant target area of the scene image or scene video so determined can then be recorded by the camera, read or transmitted and then further processed by the system, in particular by the evaluation device, and used, for example, for a registration.

The ambient data ultimately provided by the temporal and/or spatial selection can be advantageously used to perform an efficient registration with previously recorded reference images or videos, and on the basis of this registration, which can also be carried out in parallel or successively, for multiple users, and thus multiple image streams, viewing data streams and possibly additional input or trigger data, and on this basis to undertake visual and quantitative aggregation and/or comparison of viewing tracks and possibly other associated events. The reference image can, for example, also be a reduced or unchanged scene image or can be composed of a plurality of reduced scene images or even unchanged scene images. Furthermore, the image data may also be used to achieve a more efficient registration of visually marked objects or scene areas, for example, by long fixation or by fixating and voice command or key press and so on, or of continuously observed objects or scene areas, with overlays in a transparent head-mounted display, which does not have to process and/or search the entire scene video, for example, as in a content analysis such as by OCR (optical character recognition) for signage, for example, in order to translate only the sign the user is currently looking at. Other possible applications also include the determination of relevant objects or areas in the reference image and thus a gradual reduction in the bandwidth of the image streams to be analyzed, based on the idea that the eye is the best ‘feature extractor’.

In addition, numerous other possible applications emerge from this, in which large amounts of data can be saved in the same way. For example, a user may be given a view of a detail, or a zoom view or an x-ray view of a viewed object; an efficient simultaneous localization and mapping (SLAM) and an assembly of the scene or objects in the scene, preferably using the angle and depth of vergency between the captured fixations in order to create a 3D map of the space, especially over time and possibly over multiple users. In this case, the relative position of the selected area on the sensor can also be used for this, or it is conceivable that further selected areas on the sensor be set relative to a current selected area in order to enable a more robust detection. In addition, the possibility is provided of upgrading properties for registered objects or scene clips by means of contextual information, such as distance, gaze track, fixation behavior and so on, in order to make feature assignment and creation more robust. Mosaicing of the reference image is enabled as well as an improvement of its spatial resolution over time and over users. In addition, these overlays can also be calculated as a function of the point of regard or viewing track for a target object, such as a target point of regard or target track and then positioned on the basis of target and actual values.

The apparatus according to the invention and the method according to the invention can thus be used for a multitude of possible applications in which significant improvements are thereby made possible, while at the same time saving a great deal of time and computing capacity.

### LIST OF REFERENCE NUMBERS

10 Apparatus

12 Environment

14 Glasses

16 Scene camera

18 Field of view of the scene camera

20a, 20b Eye camera

22 Evaluation device

21 Display

23 Pre-processing device

24 Eye

25 Communicative connection

26 Image

28 Surrounding area

30 Gaze direction

32 Point of regard

34a, 34b Object

36a, 36b, 36c Area

1-17. (canceled)

18. A method comprising:
determining an eye parameter of a user;
generating a spatiotemporal selection based on the eye parameter of the user; and
applying the spatiotemporal selection to scene image data including one or more images of an environment including the user during the acquisition of the scene image data by a camera, transmission of the scene image data from the camera to a processor, or evaluation of the scene image data by the processor.

19. The method of claim 18, wherein applying the spatiotemporal selection to the scene image data includes treating a first part of the scene image data specified by the spatiotemporal selection in a first predefinable manner and treating a second part of the scene image data not specified by the spatiotemporal selection in a second predefinable manner.

20. The method of claim 19, wherein treating the second part of the scene image data in the second predefinable manner includes compressing the second part of the scene image data as compared to the first part of the scene image data treated in the first predefinable manner.

21. The method of claim 19, wherein treating the second part of the scene image data in the second predefinable manner includes downsampling the second part of the scene image data as compared to the first part of the scene image data treated in the first predefinable manner.

22. The method of claim 19, wherein treating the second part of the scene image data in the second predefinable manner includes not acquiring the second part of the scene image data, not transmitting the second part of the scene image data, or not evaluating the second part of the scene image data.

23. The method of claim 18, wherein the eye parameter includes a point of regard of the user and the spatiotemporal selection includes selection of a first area of the scene image data surrounding the point of regard of the user.

24. The method of claim 18, wherein the eye parameter includes classification of eye movement of the user as a fixation or a saccade and the spatiotemporal selection includes selection of times when the eye movement of the user is classified as a fixation.

25. The method of claim 18, wherein the eye parameter includes an eye opening state of the user and the spatiotemporal selection includes selection of times when the eye opening state of the user is an open state.

26. The method of claim 18, further comprising displaying an augmented reality environment based on the scene image data after applying the spatiotemporal selection.

27. The method of claim 26, wherein evaluation of the scene image data by the processor includes recognition of objects in the scene image data and displaying the augmented reality environment includes displaying information regarding recognized objects.

28. An apparatus comprising:
an eye camera to capture eye image data including one or more images of an eye of a user;
a scene camera to capture scene image data including one or more images of an environment including the user; and
a processor to:
determine an eye parameter of a user based on the eye image data;
generate a spatiotemporal selection based on the eye parameter of the user; and
apply the spatiotemporal selection to the scene image data during the acquisition of the scene image data by the scene camera, transmission of the scene image data from the scene camera to the processor, or evaluation of the scene image data by the processor.

29. The apparatus of claim 28, wherein the processor is to apply the spatiotemporal selection to the scene image data by treating a first part of the scene image data specified by the spatiotemporal selection in a first predefinable manner and treating a second part of the scene image data not specified by the spatiotemporal selection in a second predefinable manner.

30. The apparatus of claim 28, wherein the processor is to treat the second part of the scene image data in the second predefinable manner by compressing or downsampling the second part of the scene image data as compared to the first part of the scene image data treated in the first predefinable manner.

31. The apparatus of claim 28, wherein the processor is to treat the second part of the scene image data in the second predefinable manner by not acquiring the second part of the scene image data, not transmitting the second part of the scene image data, or not evaluating the second part of the scene image data.

32. The apparatus of claim 28, wherein the eye parameter includes a point of regard of the user and the spatiotemporal selection includes selection of a first area of the scene image data surrounding the point of regard of the user.

33. The apparatus of claim 28, wherein the eye parameter includes classification of eye movement of the user as a fixation, a saccade, or a blink and the spatiotemporal selection includes selection of times when the eye movement of the user is classified as a fixation.

34. A non-transitory computer-readable medium having instructions encoded thereon which, when executed, cause a processor to perform operations comprising:
determining an eye parameter of a user;
generating a spatiotemporal selection based on the eye parameter of the user; and
applying the spatiotemporal selection to scene image data including one or more images of an environment including the user during the acquisition of the scene image data by a camera, transmission of the scene image data from the camera to a processor, or evaluation of the scene image data by the processor.

35. The non-transitory medium of claim 34, wherein applying the spatiotemporal selection includes compressing or downsampling the second part of the scene image data as compared to the first part of the scene image data treated in the first predefinable manner.

36. The non-transitory medium of claim 34, wherein applying the spatiotemporal selection includes not acquiring the second part of the scene image data, not transmitting the second part of the scene image data, or not evaluating the second part of the scene image data.

37. The non-transitory medium of claim 34, wherein the eye parameter includes a point of regard of the user and the spatiotemporal selection includes selection of a first area of the scene image data surrounding the point of regard of the user.
